(19) United States
(12) Patent Application Publication
(10) Pub. No.: US 2007/0107633 A1
(43) Pub. Date: May 17, 2007

(54) Solid pigment preparations and the dispersions thereof in organic solvents, method for the production thereof, and use of the same

(75) Inventors: Susanne Piontek, Munster (DE); Jan Berg, Munster (DE); Michael Mauss, Neustadt (DE); Christopher Hilger, Munster (DE); Gunther Etzrodt, Stuttgart (DE); Norbert Schneider, Altrip (DE)

Correspondence Address: BASF CORPORATION;Patent Department, 1609 BIDDLE AVENUE, MAIN BUILDING, WYANDOTTE, MI, 48192, US

(73) Assignee: BASF Coatings Akiengesellschaft, Munster (DE)

(21) Appl. No.: 10/564,456

(22) PCT Filed: Jul. 8, 2004
(86) PCT No.: PCT/EP04/07454

§ 371 Date: Jan. 12, 2006

(30) Foreign Application Priority Data
Jul. 28, 2003 (DE) 103 34 308.3

(51) Int. Cl. C09K 11/06; C09C 1/00

(52) U.S. Cl. 106/403; 106/499; 252/301.35; 252/301.16; 252/301.36; 106/415; 106/493

(57) ABSTRACT

Solid pigment preparations containing (A) at least one pigment in a higher concentration than that which corresponds to the subsequent application and (B) at least one carrier material selected from the group consisting of oligomers and polymers which have a glass transition temperature >30° C. and a melting point or melting range below their decomposition temperature, prepared by dispersing the pigment or pigments (A) or the pigment or pigments (A) and at least one constituent (D) in the melt of the carrier material or materials (B) or in the melt of the carrier material or materials (B) and at least one constituent (D) with a power input of from 0.1 to 1.0 kW/kg for from 0.5 to 5 hours in a discontinuously operating dispersing apparatus, and then discharging the mixture from the dispersing apparatus and allowing it to cool and solidify. The preparation and use of said pigment preparations.

The present invention relates to novel solid, especially pulverulent, pigment preparations. The present invention also relates to novel dispersions of pigment preparations in organic solvents. The present invention further relates to a novel process for preparing solid pigment preparations and dispersions thereof in organic solvents. The present invention relates not least to the use of the novel solid, especially pulverulent, pigment preparations and dispersions thereof in organic solvents for preparing pigmented powders, especially polymer pellets and powder coating materials, and mixer systems.

Powder coating materials and processes for preparing them are known, for example, from the BASF Coatings AG brochures “Pulverlacke, für industrielle Anwendungen”, January 2000, or “Coatings Partner, Pulverlack Spezial”, January 2000. The powder coating materials are thermoplastic or curable powder coating materials, i.e., meltable and curable precursors of thermosetting polymers which are applied in powder form to preferably metallic substrates. This is normally done using powder coating units as described in the brochures cited above. In this process the two fundamental advantages of powder coating materials are manifested: the complete or substantial absence of organic solvents, and the ease of recycling the powder coating overspray to the coating process.

Irrespective of the particular powder coating units and processes employed, the powder coating materials are applied in a thin layer to the substrate and melted, forming a continuous powder coating film, after which the resultant coating is cooled. In the case of the curable powder coating materials, curing takes place during or after the melting of the powder coating film. The minimum curing temperature is preferably above the melting range of the powder coating material, so that melting and curing are separated from one another. This has the advantage that the powder coating melt, owing to its comparatively low viscosity, flows out effectively before the cure sets in.

The preparation of the powder coating materials embraces a very large number of steps and is therefore a comparatively complicated process. First of all, the binders of the powder coating materials must be coarsely milled. Subsequently the individual components of the powder coating materials, such as binders and functional constituents such as crosslinking agents, pigments or typical powder coatings additives are mixed with one another and extruded in special extruders. The extrudate is discharged and cooled, for example, on a cooling belt. The extrudate fragments are prefractionated, then finely milled and screened (with the oversize being returned to the fine mill), after which the resultant powder coating material is weighed and packed.

Since the powder coating extruders are not highly efficient mixing units or dispersing units for relatively hard-to-disperse pigments, such pigments are not in a fully dispersed state within the powder coating materials. A consequence of this is that, in the event of any shade correction step or subsequent tinting operation, the powder coating materials in question will alter their shade even without the addition of corrective pigments, in the course of a further passage through a powder coating extruder, since pigments which have not yet been fully dispersed will be dispersed further, thereby developing additional tinting strength. This extremely disadvantageous phenomenon is also referred to as “tinting strength reserve” (cf. European patent application EP 1 026 212 A1, page 2, para. [0004]). All in all this phenomenon leads to increased pigment consumption and to quality problems.

This is particularly the case with transparent pigments and effect pigments.

Pigmented powder coating materials appear transparent when the pigment particles are <15 nm in size. These small primary pigment particles, however, have a strong tendency to agglomerate. The agglomerates can be comminuted only with great effort in special mills. With regard to their incorporation into the powder coating materials it is generally impossible, even using special extruders, to produce transparent colorations, with hard-to-disperse pigments, such as wet-chemically prepared, transparent iron oxide pigments, pigment-grade carbon blacks or perylene pigments, without inhomogeneities.

In the case of effect pigments based on leaflet-shaped pigment particles, their incorporation into the powder coating materials is frequently observed to be accompanied by a change in the particle size and morphology. The colorations obtained are then coloristically less attractive than the coatings produced with these effect pigments on the basis of wet coating materials, and lack the brightness and the typically deep-seated satin sheen. Aluminum effect pigments turn gray, and in the case of mica effect pigments the optical effect can no longer be observed at all.

These adverse phenomena cause great problems especially when scaling up powder coating formulas from the laboratory scale, which operates with a small laboratory extruder, to the production scale, where a large production extruder is used, since extruders of different dimensions often give different dispersing results. For these reasons, when formulating the shade of powder coating materials, the possibilities for using a paint formula calculation based on standard colorations of the particular pigments employed are extremely limited and are subject to a relatively high degree of error.

Attempts have been made to solve these problems by means of solid pigment preparations in which the pigments are in predispersed form at a greater concentration than that which corresponds to their subsequent application.

Pigment preparations of this kind are offered, for example, by Ciba Specialty Chemicals under the brand name Microlen®. These preparations comprise the pigments in dispersion in urea-alkyd resins. Although the Microlen® pigment preparations can be processed without dust and have a relatively constant tinting strength, they have the great disadvantage that the urea-alkyd resins used are not original constituents of the powder coating materials into which the pigment preparations are to be incorporated. In powder coating materials it is normal to use carboxy-functional or hydroxyl-functional polyester resins, epoxy resins or polyacrylate resins. Consequently there is a risk that the urea-alkyd resins used will not be compatible with these resins and will separate. There may also be inadequate chemical attachment of the vehicle of the Microlen® pigment preparations to the binder matrix of the powder coating materials in question or of the powder coatings produced from them. Furthermore, powder coating formulas are usually optimized for specific properties, which arise form the requirements of the particular end use. For example, for powder coating materials which are to be used outdoors for coating facing elements, all of the formula ingredients used have particularly high weather resistance and light (including UV) stability. The profiles of requirements which arise from the numerous end uses for powder coating materials can be so different that it is impossible to ensure that the vehicle of the Microlen® pigment preparations will be able to satisfy the particular requirements.

The production of solid pigment preparations is also disclosed in international patent application WO 95/31507 A1 and European patent application EP 1 026 212 A1. It is proposed therein to mix an aqueous pigment dispersion and an aqueous binder dispersion with one another and to apply the mixture by spray drying. It is also proposed that the resultant pigment preparations be processed together with the other constituents of powder coating materials in conventional manner to give coloring powder coating materials. The process, however, is difficult if not impossible to operate with effect pigments.

The processes described above may possibly improve the incorporation of pigments in the case of the conventional preparation of color and/or effect powder coating materials. They are unable, however, to remove the substantial disadvantage that the shades and/or optical effects continue to be dependent on the original weighed-out batch and that subsequent tinting of color and/or effect powder coating materials which deviate from the set specification is not an option.

German patent applications DE 100 57 164 A1 and DE 100 57 165 A1 disclose solid pigment preparations in granular form which comprise a pigment and at least one thermoplastic polymer. They are prepared by dispersing the pigment in a solution of the polymer and then forming granules with removal of the solvent. The granules can be formed, for example, by applying the pigment dispersion to the thermoplastic polymer powder in a fluidized bed drier and, in doing so, evaporating the solvent. The pigment preparations are used for coloring polymer molding compounds and laminated films; whether they are also suitable for preparing powder coating materials is not disclosed by the two patent applications.

Viewed per se, the known solid pigment preparations still have a certain “tinting strength reserve” which transfers deleteriously to the powder coating materials, polymer molding compounds, and laminated films produced using them.

Where the known solid pigment preparations are redispersed in organic solvents and used in that form for the tinting of pigmented powder coating materials, additional problems arise, which result in particular from incomplete dispersion of the pigments during the production of the solid pigment preparations and from unsatisfactory stability of the redispersed pigment preparations. Accordingly, hiding drawdowns of the redispersed pigment preparations frequently show insufficient gloss and a tinting strength which is inadequate in view of the amount of pigments used.

In order to avoid the step of redispersing solid pigment preparations it is possible when preparing and tinting pigmented powder coating materials to use the original dispersions of pigments in organic binder solutions directly, as proposed in international patent applications WO 02/088261 A1 and WO 02/42384 A1. It is not possible by this means, however, to remove the problems arising from unsatisfactory stability of pigment dispersions. Nor is it possible reliably to avoid the development of a “tinting strength reserve” in the resultant powder coating materials. Furthermore, the original pigment dispersions, especially those of relatively low stability, will naturally have a lower storage stability than the solid pigment preparations produced from them. Only in exceptional cases, therefore, is it possible to transport them over longer distances, and in many cases they must be prepared immediately prior to use or stirred continually during their storage in order to prevent settling.

It is an object of the present invention to provide novel solid pigment preparations which no longer have the disadvantages of the prior art but which instead
can be produced simply and with very good reproducibility,
can be adapted particularly easily to the physical composition and to the profile of performance properties of the pigmented powders to be prepared with them, especially powder coating materials and polymer pellets, and also to the profile of performance properties of the pigmented products to be produced from them, in particular the pigmented coatings, polymer moldings, and polymer films,
have only a very low “tinting strength reserve”, if any at all, so that
shade formulation can be carried out without problems by means of a paint formula calculation which is based on standard colorations of the specific pigments used, and
they can be redispersed very easily in organic solvents, and the resultant pigment dispersions
are particularly stable,
give hiding drawdowns of particularly high gloss and particularly high tinting strength,
are outstandingly suitable for the preparation and tinting of pigmented powders, especially powder coating materials and polymer pellets, and
allow the provision of mixer systems, especially mixer systems in conjunction with color mixing formula systems.

The pigmented powders tinted or produced using the novel solid pigment preparations and the novel pigment preparations redispersed in organic solvents, especially the pigmented powder coating materials and the pigmented polymer pellets, ought to give pigmented products, especially pigmented coatings, polymer moldings, and polymer films, which have particularly high gloss, particularly high hiding power, and very good mechanical properties.

Furthermore, the novel solid pigment preparations and the novel pigment preparations redispersed in organic solvents, i.e., the novel pigment dispersions, ought to allow not only the production and/or tinting of powders but also that of liquid coating materials based on organic solvents.

The pigmented liquid coating materials tinted or produced using the novel solid pigment preparations and the novel pigment preparations redispersed in organic solvents ought also to give pigmented products, especially pigmented coatings, polymer moldings, and polymer films which have particularly high gloss, particularly high hiding power, and very good mechanical properties.

The invention accordingly provides the novel solid pigment preparations comprising
(A) at least one pigment in a higher concentration than that which corresponds to the subsequent application and
(B) at least one carrier material selected from the group consisting of oligomers and polymers which have a glass transition temperature >30° C. and a melting point or melting range below their decomposition temperature,

preparable by dispersing the pigment or pigments (A) or the pigment or pigments (A) and at least one constituent (D) in the melt of the carrier material or carrier materials (B) or in the melt of the carrier material or carrier materials (B) and at least one constituent (D) with a power input of from 0.1 to 1.0 kW/kg for from 0.5 to 5 hours in a discontinuously operating dispersing apparatus, and then discharging the mixture (A/B) or (A/B/D) from the dispersing apparatus and allowing it to cool and solidify.

The novel solid pigment preparations are referred to below as “pigment preparations of the invention”.

Further subject matter of the invention will emerge from the description.

In the light of the prior art it was surprising and unforeseeable for the skilled worker that the object on which the present invention was based could be achieved by means of the pigment preparations of the invention.

In particular it was surprising that the pigment preparations of the invention
could be produced simply and with very good reproducibility,
could be adapted particularly easily to the physical composition and to the profile of performance properties of the pigmented powders to be prepared with them, especially powder coating materials and polymer pellets, and also to the profile of performance properties of the pigmented products to be produced from them, in particular the pigmented coatings, polymer moldings, and polymer films,
had only a very low “tinting strength reserve”, if any at all, so that
shade formulation could be carried out without problems by means of a paint formula calculation which is based on standard colorations of the specific pigments used, and with few if any errors, and
they could be redispersed very easily in organic solvents, and the resultant pigment dispersions
were particularly stable,
gave hiding drawdowns of particularly high gloss and particularly high tinting strength,
were outstandingly suitable for the preparation and tinting of pigmented powders, especially powder coating materials and polymer pellets, and
allow the provision of mixer systems, especially mixer systems in conjunction with color mixing formula systems.

It was surprising, moreover, that even pigment preparations of the invention of hard-to-disperse pigments (A) or mechanically sensitive leaflet-shaped effect pigments (A) could be produced without problems.

It was surprising, furthermore, that the novel pigmented powders tinted or produced using the pigment preparations of the invention and using the novel pigment preparations of the invention redispersed in organic solvents (referred to below for the sake of brevity as “dispersions of the invention”), especially the novel pigmented powder coating materials and the novel pigmented polymer pellets, gave novel pigmented products, in particular novel pigmented coatings, polymer moldings, and polymer films, which have particularly high gloss, particularly high hiding power and very good mechanical properties.

Even more of a surprise was the extremely broad applicability of the inventive pigment preparations, dispersions, powders, especially the powder coating materials and polymer pellets, and also of the inventive products, particularly of the coatings, polymer moldings, and polymer films.

A surprise not least was that the novel solid pigment preparations and also the novel pigment preparations redispersed in organic solvents, i.e., the novel pigment dispersions, allowed not only the production and/or tinting of powders but also that of liquid coating materials based on organic solvents.

The pigmented liquid coating materials tinted or produced by means of the novel solid pigment preparations and of the novel pigment preparations redispersed in organic solvents also gave pigmented products, especially pigmented coatings, polymer moldings, and polymer films, which had particularly high gloss, particularly high hiding power and very good mechanical properties.

The pigment preparations of the invention comprise at least one pigment (A). The number of pigments (A) present is guided in particular by the intended use of the pigment preparations of the invention and by the dispersibility of the particular pigments (A) used. Thus it is of advantage, for producing a pigment preparation of the invention, to use only pigments (A) of comparable dispersibility.

The pigments (A) are used in the pigment preparations of the invention in a concentration higher than that which corresponds to the subsequent application (on this point see also Römpp-Online 2002, “pigment preparations”).

The pigments (A) are preferably selected from the group consisting of organic and inorganic, transparent and opaque, color and/or effect, fluorescent, phosphorescent, electrically conductive, and magnetically shielding pigments and transparent and opaque metal powders, and also organic and inorganic, transparent and opaque fillers and nanoparticles.

Examples of suitable pigments (A) are described in detail in, for example,
international patent application WO 02/088261 A1, page 13 line 28 to page 15 line 20 and page 15 line 30 to page 16 line 19;
international patent application WO 02/42384 A1, page 22 line 1 to page 23 line 23 and page 24 lines 1 to 22;
German patent application DE 100 57 164 A1, page 2 paragraph [0011] to page 4 paragraph [0022]; or
German patent application DE 100 57 165 A1, page 2 paragraph [0012] to page 4 paragraph [0024].

The pigment preparations of the invention further comprise at least one, especially one, carrier material (B).

The carrier material (B) is selected from the group consisting of oligomers and polymers (cf. Römpp-Online 2002, “oligomers” and “polymers”) which have a glass transition temperature >30° C., preferably between 30 and 200° C. (cf. Römpp-Online 2002, “glass transition temperature”) and a melting point or melting range below their decomposition temperature. The oligomers and polymers (B) preferably do not decompose within a temperature range of at least 100° C. above their glass transition temperature.

The physical composition and also the chemical and physical properties of the carrier materials (B) are guided primarily by their dispersing capacity for the particular pigments (A) to be dispersed and by their intended use, in particular by the physical composition of the powders to be tinted or produced with a pigment preparation of the invention, in particular the powder coating materials and polymer pellets, and also the liquid coating materials. The carrier material (B) is preferably selected such that it has a profile of chemical, physical, and performance properties which is comparable, and preferably identical, with the profile of properties of at least one of the essential constituents, in particular of at least one binder, which is present in the inventive powders or liquid coating materials based on organic solvents (conventional coating materials).

Use is made in particular as carrier materials (B) of the oligomeric and polymeric binders of thermoplastic powder coating materials or of powder coating materials curable thermally and/or with actinic radiation or of conventional coating materials.

Thermoplastic oligomers and polymers (B) in particular are used when the pigment preparations of the invention in question serve for producing or tinting thermoplastic powders, especially thermoplastic powder coating materials and polymer pellets.

Examples of suitable thermoplastic oligomers and polymers (B) are described in detail in, for example,
international patent application WO 02/088261 A1, page 23 line 21 to page 27 line 20; or
German patent application DE 100 57 164 A1, page 4 paragraph [0023] to page 5 paragraph [0039].

Oligomers and polymers (B) containing reactive functional groups for the thermal cure and/or for the actinic radiation cure are used in particular when the pigment preparations of the invention in question serve for producing or tinting powders curable thermally and/or with actinic radiation, especially powder coating materials and polymer pellets curable thermally and/or with actinic radiation, and also conventional coating materials.

For the purposes of the present invention actinic radiation means electromagnetic radiation, such as near infrared (NIR), visible light, UV radiatiori, X-rays, and gamma radiation, especially UV radiation, and corpuscular radiation, such as electron beams, beta radiation, proton beams, neutron beams or alpha radiation, especially electron beams.

Examples of suitable oligomers and polymers (B) curable thermally and/or with actinic radiation are described in detail in international patent application WO 02/42384 A1, page 27 line 17 to page 38 line 26 in conjunction with page 18 line 27 to page 21 line 29.

The amount of the pigments (A) and carrier materials (B) in the pigment preparations of the invention can vary very widely and is guided primarily by the dispersing capacity of the carrier materials (B) and the dispersibility of the pigments (A) and also by the intended use. The pigment preparations of the invention preferably contain, based in each case on the pigment preparation, from 1 to 85%, more preferably from 1 to 80%, and in particular from 1 to 70% by weight of at least one pigment (A) and from 15 to 99%, more preferably from 20 to 99%, and in particular from 30 to 99% by weight of at least one carrier material (B).

The pigment preparations of the invention may further comprise at least one functional constituent (D). The constituent (D) is preferably selected from the group consisting of additives and dyes, especially additives and dyes typical for powder coating materials. The additives are preferably selected from the group consisting of crosslinking agents, UV absorbers, light stabilizers, free-radical scavengers, devolatilizers, slip additives, polymerization inhibitors, crosslinking catalysts, thermolabile free-radical initiators, photoinitiators, thermally curable reactive diluents, reactive diluents curable with actinic radiation, adhesion promoters, leveling agents, film-forming auxiliaries, flame retardants, corrosion inhibitors, free-flow aids, waxes, and flatting agents. The additives and dyes are used in amounts such that in the conventional coating materials or powders tinted or produced by means of the pigment preparation of the invention the resultant amounts are those which are customary and known and are effective.

Examples of suitable additives and dyes are described in international patent application WO 02/42384 A1, page 12 line 16 to page 18 line 25, page 23 lines 25 to 31, and page 25 line 1 to page 26 line 21. Further suitable additives are detailed in the textbook “Lackadditive” [Additives for coatings] by Johan Bieleman, Wiley-VCH, Weinheim, N.Y., 1998.

The pigment preparations of the invention can be produced by dispersing the pigment or pigments (A) or the pigment or pigments (A) and at least one constituent (D) in the melt of the carrier material or carrier materials (B) or in the melt of the carrier material or carrier materials (B) and at least one constituent (D) with a power input of from 0.1 to 1.0, preferably from 0.2 to 0.8, and in particular from 0.2 to 0.6 kW/kg for from 0.5 to 5 hours, preferably from 0.75 to 4 hours, and in particular from 0.75 to 3 hours in a discontinuously operating dispersing apparatus, and then discharging the mixture (A/B) or (A/B/D) from the dispersing apparatus and allowing it to cool and solidify.

Suitable discontinuously operating (batchwise) dispersing apparatus includes that used for the intensive mixing of substances of high viscosity. Only such dispersing apparatus is able to input the power per kilogram of mixture (A/B) or (A/B/D) that is necessary for dispersing the pigments (A) and, where present, the constituents (D) in the melts (B) or (B/D) within the necessary period of time. Preference is given to using double-arm kneading apparatus (cf. Ullmann's Encyclopedia of Industrial Chemistry, Fifth Edition on CD-ROM, 1997 Wiley-VCH, Weinheim-Germany, “Mixing of Highly Viscous Media” and Römpp-Online 2002, Georg Thieme Verlag, Stuttgart, N.Y., “dispersing equipment”).

The solidified mixtures (A/B) or (A/B/D) are pulverized or granulated to give the pigment preparations of the invention. For the pulverizing or granulating it is possible to use the milling units which are customary and known in the field of powder coatings production or the field of polymer pellet production, especially impact mills or classifier mills (cf. Römpp-Online 2002, Georg Thieme Verlag, Stuttgart, N.Y., “milling”). The fineness to which milling is carried out may vary very widely and is guided primarily by the intended use of the pigment preparations of the invention and in particular by how they are specifically processed further. The average particle size of the pigment preparations of the invention is preferably from 10 μm to 1 mm. It is, however, also possible to set smaller or larger average particle sizes if the specific end use requires it.

The pigment preparations of the invention can be put to a very wide variety of end uses.

They are preferably used for producing or tinting pigmented powders, especially pigmented powder coating materials and polymer pellets, in which the pigments (A) are present in concentrations in accordance with the application. For this purpose the pigment preparations of the invention can be premixed with the other constituents of the pigmented powders in the desired proportions. The solid mixtures which result can be melted again subsequently and, for example, homogenized in an extruder. The resulting homogenized mixtures, following discharge from the extruder, can be cooled, fractionated, milled, and, if desired, classified.

Depending on their intended use the resultant powders of the invention are adjusted to different average particle sizes and particle size distributions.

Where, for example, the powders of the invention are used as powder coating materials, the average particle size is preferably from 1 to 200 μm, more preferably from 2 to 150 μm, and in particular from 3 to 100 μm. By average particle size is meant the 50% median figure determined by the laser diffraction method; i.e., 50% of the particles have a diameter≦the median and 50% of the particles have a particle diameter≧the median. Particular preference is given to setting narrow particle size distributions as are described, for example, in European patent EP 0 666 779 B1.

Alternatively these powder coating materials of the invention can be dispersed in aqueous media, to give powder coating dispersions or powder slurries which can be processed like conventional liquid coating materials (cf. patent applications DE 195 40 977 A1, DE 195 18 392 A1, DE 196 17 086 A1, DE 196 13 547 A1, DE 5 196 18 657 A1, DE 196 52 813 A1, DE 196 17 086 A1, DE 198 14 471 A1, DE 198 41 842 A1 or DE 198 41 408 A1).

In the powder coating materials and powder slurries of the invention the “tinting strength reserve” is either absent or only very small, and consequently they lead, in a very reproducible way, to coatings having an outstanding profile of performance properties.

Where the powders of the invention are used as polymer pellets they will generally have larger particle sizes than the powder coating materials and powder slurries of the invention. The average particle size is preferably from 200 μm to 6 mm, in particular from 500 μm to 6 mm. The polymer pellets of the invention likewise have only a very low “tinting strength reserve”, if any, and therefore lead, in a very reproducible way, to polymer molding compounds and polymer films having an outstanding profile of performance properties.

Alternatively the pigment preparations of the invention can be used for producing and tinting pigmented conventional coating materials, and in this application they have the same advantages as for the production and tinting of pigmented powders.

Additionally, however, the pigment preparations of the invention and the powders of the invention can be dispersed in organic solvents (C) and employed in that form. Examples of suitable solvents (C) are known from D. Stoye and W. Freitag (Editors), “Paints, Coatings and Solvents”, Second, Completely Revised Edition, Wiley-VCH Weinheim, N.Y., 1998, “14.9. Solvent Groups”, pages 327 to 373.

It is preferred to use organic solvents (C) which do not enter into any disruptive interactions with the constituents of the pigment preparations of the invention, and in particular do not damage the pigments (A), which have a high solvency for the carrier materials (B) and also, where used, for the further constituents (D), and which evaporate readily under drying conditions normally encountered in practice. The skilled worker is therefore able to select suitable organic solvents (C) with ease on the basis of their known solvency and their reactivity. Examples of particularly suitable organic solvents (C) are described in German patent application DE 100 57 165 A1, page 6 paragraph [0056].

The dispersing of the pigment preparations of the invention in organic solvents (C) has no special features in terms of its method but can instead be carried out by means of the customary and known dispersing equipment (cf. Römpp-Online 2002, Georg Thieme Verlag, Stuttgart, N.Y., “dispersing equipment”).

The resultant dispersions of the invention have a solids content of preferably from 20 to 80%, more preferably from 20 to 75%, and in particular from 25 to 70% by weight. They preferably contain, based in each case on the solids of the dispersion, from 1 to 85%, more preferably from 1 to 80%, and in particular from 1 to 70% by weight of at least one pigment (A) and from 15 to 99%, more preferably from 20 to 99%, and in particular from 30 to 99% by weight of at least one carrier material (B).

The dispersions of the invention are outstandingly suitable for producing pigmented powders and conventional coating materials and also for producing mixer systems. The mixer systems in turn are likewise outstandingly suitable for producing and/or for tinting pigmented powders, especially powder coating materials and polymer pellets, and also conventional coating materials.

The powders of the invention are produced by applying the dispersions of the invention to the surface of the dimensionally stable particles with partial, substantially complete, or complete evaporation of the solvent or solvents (C).

In this operation it is possible to apply only one dispersion of the invention. It is, however, a particular advantage of the powders and of the process of the invention that at least two dispersions of the invention can be applied simultaneously or successively to the surface of the dimensionally stable particles. This massively expands the possibilities for varying and controlling the physical composition and the distribution of the pigments (A) and also, where appropriate, of the functional constituents (D) in and/or on the dimensionally stable particles.

It is of advantage in accordance with the invention if the solvents (D) are evaporated at temperatures below the glass transition temperature, Tg, or the minimum film-forming temperature of the binders (cf. Römpp Lexikon Lacke und Druckfarben, Georg Thieme Verlag, Stuttgart, N.Y., 1998, page 391, “minimum film-forming temperature (MFFT)”) of the dimensionally stable particles.

It is further of advantage in accordance with the invention if the average particle size and the particle size distribution of the dimensionally stable particles are changed minimally or not at all by the application of the dispersions of the invention, unless such a change is a specific aim. This may be the case, for example, when the initial dimensionally stable particles have a comparatively low average size and the design is to construct a powder of the invention having a larger average particle size. Here again, new possibilities result for controlling and optimizing the production and composition of the powders of the invention.

“Dimensionally stable” for the purposes of the present invention means that, under the customary and known conditions of the storage and application of powders, the particles undergo only minimal agglomeration and/or breakdown into smaller particles, if at all, instead substantially preserving their original form even under the effect of shearing forces.

The particle size distribution of the dimensionally stable particles can vary comparatively broadly and is guided by the particular intended use of the powders of the invention. Preference is given to employing the average particle sizes and particle size distributions described above.

Owing to the partial, substantially complete or complete evaporation of the solvents (C) the powders of the invention are substantially free from organic solvents, and so are free-flowing and capable of application. They preferably have a residual volatile solvent content of ≦15% by weight, more preferably ≦10% by weight, and with particular preference ≦5% by weight.

The composition of the dimensionally stable particles can vary extremely widely. It is guided primarily by whether the powders of the invention to be produced are thermally self-crosslinking, thermally externally crosslinking, curable with actinic radiation, or curable by dual cure.

Where the dimensionally stable particles serve for producing thermally self-crosslinking powders they consist of or comprise at least one thermally self-crosslinking binder. Examples of suitable such binders are the thermally self-crosslinking oligomers and polymers (B) described above.

Where the dimensionally stable particles serve for producing thermally externally crosslinking powders they consist of or comprise at least one thermally externally crosslinking binder. Examples of suitable such binders are the thermally externally crosslinking oligomers and polymers (B) described above. The particles preferably further comprise at least one of the functional constituents (D) described above, in particular at least one crosslinking agent.

Where the dimensionally stable particles serve for producing actinic-radiation-curable powders they consist of or comprise at least one actinic-radiation-curable binder. Examples of suitable such binders are the actinic-radiation-curable oligomers and polymers (B) described above. The particles preferably further comprise at least one of the functional constituents (D) described above, in particular at least one of the above-described photoinitiators.

Where the dimensionally stable particles serve for producing powders curable thermally and with actinic radiation they consist of or comprise at least one dual-cure binder or at least one thermally curable binder and at least one actinic-radiation-curable binder. Examples of suitable such binders are the dual-cure oligomers and polymers or the thermally curable oligomers and polymers (B) and the actinic-radiation-curable oligomers and polymers (B) described above. The dimensionally stable particles preferably further comprise at least one of the functional constituents (D) described above, in particular at least one of the above-described photoinitiators and/or at least one crosslinking agent.

The preparation of the dimensionally stable particles has no special features as far as its method is concerned but instead takes place by means of the techniques and apparatus described in the prior art cited at the outset for the preparation of the powder coating materials from the binders, in particular the binders (B), and also, where appropriate, from the functional constituents (D).

The dimensionally stable particles can be the precursors of powder coating materials or polymer pellets which are to be completed with at least one pigment (A) and also, where appropriate, with at least one functional constituent (D) as well. Thus, for example, it is possible to coat the clear transparent precursor of a color and/or effect powder coating material with a dispersion of the invention which comprises at least one pigment (A).

The dimensionally stable particles may alternatively comprise finished pigmented powders, especially finished pigmented powder coating materials or finished pigmented polymer pellets, whose shades and/or optical effects and also, where appropriate, other functional properties require subsequent adjustment. The subsequent adjustment may be necessary, for example, if the finished pigmented powder coating material or the finished pigmented polymer pellets is or are an off-specification batch. Subsequent adjustment may alternatively be used to adapt finished pigmented powder coating materials and polymer pellets which conform to older specifications to new specifications without the need for a new production campaign.

The quantitative ratio of dispersion of the invention to dimensionally stable particles can vary very widely from one case to another. In every case the ratio is harmonized so that all of the constituents are present in the amounts required to set the particular desired profile of properties of the powders of the invention.

It is the particular advantage of the powders of the invention and of the process that, as well as the pigments (A), all functional constituents (D) typical of powder coating materials can be applied in this way. Consequently it is also possible for a powder coating material of the invention or polymer pellets of the invention with a given physical composition to be produced by different versions of the process of the invention, thereby providing new possibilities for process optimization. The same applies to the subsequent adjustment of the physical composition and/or profile of performance properties of finished pigmented powder coating materials and polymer pellets.

It is also possible for a “universal” powder to be the starting point for the process, in which case the universal powder is coated with any of a wide variety of dispersions of the invention in accordance with the intended use of the powder of the invention that is to be produced from it.

Application of the dispersions of the invention to the dimensionally stable particles may be made by means of customary and known techniques and apparatus serving for the coating of solid particles.

In accordance with the invention it is advantageous to apply the dispersions of the invention by spraying. The dispersions are preferably sprayed in a fluidized bed comprising the dimensionally stable particles.

The fluidized bed can be produced in principle using any of the customary and known techniques and apparatus suitable for the purpose. Preference is given to using fluid bed driers, especially fluid bed spray driers, fluid bed spray coaters or fluid bed spray granulators. Standard commercial spray granulators with particularly turbulent, homogeneous mixing are particularly preferred.

The fluid bed driers preferably comprise customary and known atomization units, as described for example by A. H. Lefebvre in “Atomization and Sprays” (1989 hpc, ISBN 0-89116-603-3). Pressure nozzles and two-fluid nozzles are preferred. Particular preference is given to double-flow or multiflow two-fluid nozzles, as offered by the companies Schlick, Lechler, Spraying Systems, Delavan or Gericke.

During the implementation of the process the dimensionally stable particles ate supplied continuously or in batches to the fluidized bed, in which they are coated with at least one dispersion of the invention. Where materially different dispersions of the invention are used they are preferably sprayed in at different locations. Where only one dispersion of the invention is employed it too can be sprayed in at different locations in order to optimize its distribution in the fluidized bed. In the case of continuous operation a narrow residence time distribution should be ensured.

After coating, the coated dimensionally stable particles, i.e., the powders of the invention, are discharged. The coated dimensionally stable particles can be returned to the fluidized bed (circulation mode), in which they are coated with the same dispersions of the invention and/or with other dispersions, particularly dispersions of the invention. For this purpose they may also be passed to at least one further fluid bed drier.

It is a particular advantage of the process that, following discharge from the fluid bed drier, the powder coating materials of the invention no longer require milling and/or classifying in order to set the desired particle size distribution or grain size distribution.

Here again, numerous innovative possibilities arise for controlling and optimizing the process and the physical composition and the profile of performance properties of the powders of the invention: The process can also be controlled in such a way that even thermally sensitive, catalytically active and/or highly reactive functional constituents (D) for which there is a risk that, under the conditions of the customary and known processes for preparing powders, they will decompose or that they will give rise to unwanted premature crosslinking reactions can also be incorporated into the powders of the invention. Examples of functional constituents (D) of this kind are crosslinking catalysts, crosslinking agents such as polyisocyanates, or thermolabile free-radical initiators.

The key advantage of the above-described powders of the invention and of the process, however, is that they allow the provision of the mixer system of the invention.

The mixer system serves to produce powders, especially powder coating materials and polymer pellets, and/or to subsequently adjust the physical composition and/or profile of performance properties of powders, especially of powder coating materials and polymer pellets. It serves in particular for subsequent adjustment of the shade and/or optical effect imparted by color and/or effect powders differing in chromaticity and/or intensity of the optical effects.

The mixer system comprises at least two adjustment modules (I) and at least one solids module (II). Preference is given to employing from 3 to 50 adjustment modules (I).

An adjustment module (I) comprises in each case a dispersion comprising the above-described constituents (A), (B), and (C) and also, if used, (D). The pigments (A) can be used to set any of a very wide variety of shades and/or optical effects, and the functional constituents (D) can be used where appropriate, in addition, to set any of a very wide variety of performance properties, such as, for example, the rate of the actinic radiation cure or of the thermal cure, the anticorrosion effect and/or the weathering stability.

The adjustment modules (I) accordingly comprise different color and/or effect pigments (A), thereby producing a series of base color modules (I) from which a paint mixer system can be constructed which allows the realization, from just a few base colors, of a virtually unlimited number of different shades and/or optical effects for the coatings produced from the powder coating materials of the invention or for the moldings and films produced from the polymer pellets of the invention.

The material compositions of the powders of the invention differing in chromaticity and/or in intensity of the optical effects are preferably determined by means of a paint mixing formula system based on the base color modules (I).

The mixer system further comprises at least one solids module (II), which comprises at least one kind, in particular one kind, of the dimensionally stable particles described above. The module in question may comprise, for example, a universal powder. The selection of the particular kind of particles is guided by the intended use of the powders of the invention produced from them.

The mixer system comprises not least at least one mixing unit for mixing the contents of at least one adjustment module (I) and the contents of at least one solids module (II) under defined proportions and temperatures. The mixing unit preferably comprises a fluid bed drier. Examples of suitable fluid bed driers are those described above.

To producers of powder coating materials and polymer pellets, the mixer system offers the key advantage that for specific end uses it is no longer necessary to prepare very large quantities of a finished powder coating material or of polymer pellets but that it is possible instead, in accordance with user requirements, to adjust or prepare specifically small amounts of a powder coating material or of polymer pellets which are adapted precisely to the particular end use. All of this also makes the preparation of small amounts of polymer pellets or powder coating materials by means of the mixer system very attractive economically.

The dispersions of the invention and also the mixer system of the invention that is based on them can also be used, however, very effectively to produce and tint conventional coating materials, with the resultant conventional coating materials of the invention enjoying the same advantages, mutatis mutandis, as those described above for the powders of the invention.

The range of possible applications of the powders of the invention, especially the powder coating materials of the invention, and the conventional coating materials of the invention is extremely broad in view of their outstandingly reproducible and advantageous properties.

Accordingly, the inventive powder coating materials and conventional coating materials can be used for
the original finishing of bodies of means of transport, including aircraft, rail vehicles, watercraft, muscle-powdered vehicles and motor vehicles, both for interior and exterior applications, and also components of such vehicles,
the painting of the inside and outside of buildings,
the painting of doors, windows, furniture, and hollow glassware,
the coating of pipelines,
industrial coating, including coil coating, container coating, and the impregnation and/or coating of mechanical, optical, and electrical components;
the coating of white goods, including household appliances, boilers, and radiators; and
the coating of flanges, valves, wall-fitted wardrobes, bed frames, insulation boxes, fence posts, garden furniture, traffic barriers, road signs, shopping baskets, inserts for dishwashers, brake cylinders, laboratory equipment, and chemical plant,
   and the pigmented polymer pellets for producing moldings and films.

The paint systems, coatings, moldings, and films of the invention likewise have outstanding performance properties.

### EXAMPLES

### Examples 1 to 3 (Inventive)

The Production of Pigment Preparations 1 to 3 and of Dispersions 1 to 3

### Example 1

100 g of Uralac® 3495 from DSM Kunstharze (carboxyl-containing polyester; carrier material B) were melted at 150° C. in a laboratory kneader (model HKD-T 06 D from Ika). 200 g of titanium dioxide of type Rutile 2310 (from Kronos) (pigment A) were introduced in portions into the resulting melt. The torque of the kneader rose to about 14 Nm. The resulting melt of the pigment preparation was kneaded at 140° C. for an hour (power input: 0.32 kW/kg), discharged in melt form and, after cooling, pulverized by means of a laboratory mill so as to give an average particle size <1 mm. 100 g of the pulverized pigment preparation were stirred intensely together with 150 g of acetone in a dissolver for 20 minutes. The resulting dispersion was stable on storage and gave high-gloss drawdowns (cf. table 1).

### Examples 2 and 3

Example 1 was repeated replacing 200 g of titanium dioxide by 100 g of Hostaperm® Yellow H4G in Example 2 and by 100 g of Irgalith® Blue PDS 6 (Ciba) in Example 3 as pigments (A). The resulting dispersions were stable on storage and gave high-gloss drawdowns (cf. table 1).

### Examples C1 to C3 (Comparative)

The Production of Dispersions C1 and C3

### Example C1

A laboratory stirrer mill (model Dispermat® SL from Getzmann) containing 230 g of zirconium dioxide grinding media with a diameter of from 1 to 1.25 mm was charged with a dispersion (premixed using a dissolver) of 133 g of titanium dioxide of the type Rutile 2310, 67 g of Uralac® 3495 and 300 g of acetone and milling was carried out at 3000 rpm until the gloss of the drawdown was constant. The milling time required to achieve this was two hours. The result of the gloss measurement on the drawdown can be found in table 1.

### Examples C2 and C3

Example C1 was repeated but using, instead of 133 g of titanium dioxide and 67 g of Uralac® 3495, 100 g of Hostaperm® Yellow H4G and 100 g of Uralac® 3495, for Example C2, and 100 g of Irgalith® Blue PDS 6 (Ciba) and 100 g of Uralac® 3495, for Example C3. The milling time in Examples C2 and C3 was 2.5 hours. The results of the gloss measurements on the drawdowns can likewise be found in table 1.

Table 1 summarizes the gloss measurements to DIN 67530 (60°) on drawdowns with a dry film thickness of 40 μm of Examples 1 to 3 and of Examples C1 to C3. Direct comparison is possible between Examples 1 and C1, 2 and C2, and 3 and C3. This comparison shows that the drawdowns of the dispersions 1 to 3 from Examples 1 to 3 was superior in gloss to the drawdowns of dispersions C1 to C3 from Examples C1 to C3.

TABLE 1
Gloss measurements to DIN 67530 (60°) on drawdowns
with a dry film thickness of 40 μm of the dispersions
from Examples 1 to 3 and from Examples C1 to C3

| Example | Gloss |
|---|---|
| 1 | 88 |
| C1 | 70 |
| 2 | 69 |
| C2 | 33 |
| 3 | 68 |
| C3 | 47 |

### Examples 4 and 5 (Inventive) and Examples C4 and C5 (Comparative)

The Production of Dispersions 4 and 5 of Examples 4 and 5 and of Dispersions C4 and C5 of Examples C4 and C5

For Example 4, 25 g of the pulverized pigment preparation 2 from Example 2 and 75 g of the pulverized pigment preparation I from Example 1 were dispersed in 150 g of acetone using a dissolver.

For Example 5, 10 g of the pulverized pigment preparation 3 from Example 3 and 90 g of the pulverized pigment preparation 1 from Example 1 were dispersed in 150 g of acetone using a dissolver.

For Example C4 dispersions C1 and C2 from Examples C1 and C2 were mixed with one another in a ratio of 3:1.

For Example C5 dispersions C1 and C3 from Examples C1 and C3 were mixed with one another in a ratio of 9:1.

Hiding drawdowns of dispersions 4, 5, C4, and C5 were produced with a dry film thickness of 40 μm. The (relative) color strength equivalents (CSE) of the dispersed pigments (cf. Römpp-Online 2002, Georg Thieme Verlag, Stuttgart, N.Y., “color strength”, and DIN ISO 787, Part 24) were determined on the basis of the drawdowns. A comparison could be made between Examples 4 and C4, and between Examples 5 and C5. In this case the drawdowns of the comparative examples formed the standard in each case (CSE=100), it being possible for the drawdowns compared therewith to have CSE values <100 (better color strength) or >100 (lower color strength).

The results can be found in table 2. The relative color strength CSE of the drawdowns of Examples 4 and 5 were <100. This underscored the fact that the pigments dispersed in accordance with Examples 4 and 5, in significantly smaller amounts, gave the same coloristic effects as the pigments dispersed in accordance with Examples C4 and C5.

TABLE 2
The color strength equivalents (CSE) of the pigments
dispersed in accordance with Examples 4 and 5 and
in accordance with Examples C4 and C5

| Example | CSE |
|---|---|
| 4 | 75 |
| C4 | 100 |
| 5 | 65 |
| C5 | 100 |

### Examples 6 (Inventive) and C6 (Comparative)

The Production of Dispersion 6 of Example 6 and of Dispersion C6 of Example C6

### Example 6

For Example 6 Example 2 was repeated but replacing 100 g of Hostaperm® Yellow H4G with 100 g of Heliogen Green L 8630 from BASF Aktiengesellschaft. This gave the pulverized pigment preparation 6.

To produce dispersion 6, 10 g of the pulverized pigment preparation 6 and 90 g of the pulverized pigment preparation 1 from Example 1 were dispersed in 150 g of acetone using a dissolver. Using a portion of the freshly prepared dispersion 6, a hiding drawdown with a dry film thickness of 40 μm was produced immediately. This drawdown formed the reference against which comparison was made. Additionally, drawdowns (dry film thickness 40 μm) were produced after standing times of one hour, two hours, and 20 hours. Subsequently the colorimetric properties DE* of the drawdowns in comparison with the reference were determined in accordance with DIN 6174. The results can be found in table 3.

### Example C6

For Example C6 Example C2 was repeated but replacing 100 g of Hostaperm® Yellow H4G with 100 g of Heliogen Green L 8630. The milling time to constant gloss was three hours. This gave the precursor of dispersion C6.

The precursor was mixed together with dispersion C1 from Example C1 in a ratio of 1:9. This gave dispersion C6. Using a portion of the freshly prepared dispersion C6, a hiding drawdown with a dry film thickness of 40 μm was produced immediately. This drawdown formed the reference against which comparison was made. Additionally, drawdowns (dry film thickness 40 μm) were produced after standing times of one hour, two hours, and 20 hours. Subsequently the calorimetric properties DE* of the drawdowns in comparison with the reference were determined in accordance with DIN 6174. The results can again be found in table 3.

Comparison of the colorimetric data shows that, as a function of the standing times, DE* of the drawdowns of dispersion C6 changed to a considerably greater extent than DE* of the drawdowns of dispersion 6. This underscored the fact that dispersion 6 was considerably more stable than dispersion C6.

TABLE 3
The colorimetric properties DE* to DIN 6174 of the
drawdowns of dispersions 6 (Example 6) and C6 (Example
C6) as a function of their standing times

DE* to DIN 6174:
Standing times of the dispersions (h):

| Example | 0 | 1 | 2 | 20 |
|---|---|---|---|---|
| 6 | reference | 0 | 0.2 | 0.3 |
| C6 | reference | 0.5 | 0.8 | dispersion |
| | | | | gelled |

### Example 7 (Inventive) and Example C7 (Comparative)

The Production of the Powder Coating Materials 7 (Example 7) and C7 (Example C7) and of the Corresponding Coatings

### Example 7

150 g of the pulverized pigment preparation 1 from Example 1 and 50 g of the pulverized pigment preparation 2 from Example 2 were mixed intensely with 300 g of acetone for 20 minutes. The mixture was subsequently diluted with a further 900 g of acetone. This gave dispersion 7.

### Example C7

375 g of dispersion C1 from Example C1 and 125 g of dispersion C2 from Example C2 were mixed for 20 minutes using a high-speed stirrer. The mixture was subsequently diluted with a further 900 g of acetone. This gave dispersion C7;

The Production of Powder Coating Materials 7 (Example 7) and C7 (Example C7) and of the Corresponding Coatings:

Separately from one another in laboratory fluid bed units, dispersions 7 and C7 were each applied over the course of one hour by spraying to 2200 g in each case of an unpigmented, polyester-based standard commercial powder coating material. The maximum product temperatures within the fluidized beds were 35° C. After the end of the spraying operations the resultant powder coating materials 7 and C7 were afterdried at 35° C. for a further 30 minutes and then discharged. Separately from one another, in powder coating units, powder coating materials 7 and C7 were applied to steel panels,.with a film thickness of 180 g/m² in each case. The resultant powder coating films were cured at 180° C. for 10 minutes. This gave coatings 7 and C7, whose surfaces, hiding power, and mechanical properties were subjected to measurement. The results can be found in table 4.

Comparison of the results underscores the fact that coating 7 was superior to coating C7 in terms of gloss, hiding power, and mechanical properties.

TABLE 4
Performance properties of coatings
7 (Example 7) and C7 (Example C7)

| | | | Erichsen | Hiding |
|---|---|---|---|---|
| | | Impact test^{b)} | cupping^{c)} | power^{d)} |
| Example | Gloss^{a)} | (inch/pound) | (mm) | (%) |
| 6 | 87 | 40/20 | <2 | 100 |
| C6 | 82 | 20/10 | 8 | 76 |

^{a)}to DIN 67530 (60°);
^{b)}to ASTM D 2794;
^{c)}cf. Römpp-Online 2002, Georg Thieme Verlag, Stuttgart, New York, “Erichsen cupping”;
^{d)}determined by measuring the relative color strength (CSE) (cf. Examples 4 and 5 and Examples C4 and C5).

1. A solid pigment preparation comprising
(A) at least one pigment in a higher concentration than that which corresponds to the subsequent application and
(B) at least one carrier material selected from the group consisting of oligomers and polymers which have a glass transition temperature >30° C. and a melting point or melting range below their decomposition temperature,
prepared by dispersing the pigment or pigments (A) or the pigment or pigments (A) and at least one constituent (D) in the melt of the carrier material or carrier materials (B) or in the melt of the carrier material or carrier materials (B) and at least one constituent (D) for from 0.5 to 5 hours in a discontinuously operating dispersing apparatus with a power input of from 0.1 to 1.0 kW/kg, and then discharging the mixture (A/B) or (A/B/D) from the dispersing apparatus and allowing it to cool and solidify.

2. The pigment preparation as claimed in claim 1, which is in powder form.

3. The pigment preparation as claimed in claim 1, which is in the form of a dispersion in at least one organic solvent (C).

4. The pigment preparation claim 1, wherein the pigments (A) are selected from the group consisting of organic, inorganic, transparent, opaque, color, effect, fluorescent, phosphorescent, electrically conductive, and magnetically shielding pigments, transparent metal powders, opaque metal powders, organic fillers and nanoparticles, inorganic fillers and nanoparticles, transparent and opaque fillers and nanoparticles.

5. The pigment preparation of claim 1, wherein the oligomers and polymers (B) have a glass transition temperature of between 30 and 200° C.

6. The pigment preparation of claim 1, wherein the oligomers and polymers (B) do not decompose within a temperature range of at least 100° C. above their glass transition temperature.

7. The pigment preparation of claim 1, comprising, based on the pigment preparation, from 1 to 85% by weight of at least one pigment (A) and from 15 to 99% by weight of at least one carrier material (B).

8. The pigment preparation of claim 3, comprising, based on the solids of the dispersion, from 1 to 85% by weight of at least one pigment (A) and from 15 to 99% by weight of at least one carrier material (B).

9. The pigment preparation of claim 3, having a solids content of from 20 to 80% by weight.

10. The pigment preparation of claim 1, comprising constituent (D) selected from the group consisting of additives and dyes.

11. The pigment preparation of claim 10, wherein the additives are selected from the group consisting of crosslinking agents, UV absorbers, light stabilizers, free-radical scavengers, devolatilizers, slip additives, polymerization inhibitors, crosslinking catalysts, thermolabile free-radical initiators, photoinitiators, thermally curable reactive diluents, reactive diluents curable with actinic radiation, adhesion promoters, leveling agents, film-forming auxiliaries, flame retardants, corrosion inhibitors, free-flow aids, waxes, and flatting agents and mixtures thereof.

12. The pigment preparation of claim 1, wherein the dispersing apparatus is a kneading apparatus.

13. A process for producing a pigment preparation claim 1 by mixing together constituents (A) and (B) and optionally (C) and/or (D), comprising
(1) in a first step in dispersing apparatus
dispersing the pigment or pigments (A) or
the pigment or pigments (A) and at least one constituent (D)
in the melt
of the carrier material or carrier materials (B) or
of the carrier material or carrier materials (B) and at least one constituent (D)
with a power input of from 0.1 to 1 kW/kg for from 0.5 to 5 hours, and then
(2) in a second step discharging the resulting mixture (A/B) or (A/B/D) from the dispersing apparatus and allowing it to cool and solidify.

14. The process as claimed in claim 13, wherein
(3) the solidified mixture (A/B) or (A/B/D) is pulverized.

15. The process of claim 13, wherein
(4) the solidified mixture (A/B) or (A/BID) is dispersed in at least one organic solvent (C).

16-22. (canceled)

23. A coating comprising at least one of a pigmented powder coating or liquid coating material based on organic solvents comprising the pigment preparation of claim 1.

24. A mixer system comprising the pigment preparation of claim 1, for producing or tinting at least one of powder coating material or solvent based coating materials.

25. A mixer system according to claim 24 comprising
(I) at least two adjustment modules each comprising a dispersion as set forth in claim 1 and
(II) at least one solids module comprising pigmented or unpigmented, dimensionally stable powders.

26. A powder coating composition according to claim 23 wherein the oligomers and polymers (B) of the pigment preparation, are identical with the binders present in the powder coating.

27. A powder coating composition according to claim 23, wherein the powders are polymer pellets or powder coating materials.

28. A substrate coated with a powder coating according to claim 23, where said substrate is selected from the group consisting of
interior and exteriors of transportion including at least one of aircraft, rail vehicles, watercraft, and automobiles, components of transportation vehicles, building interiors and exteriors, doors, windows, furniture, hollow glassware, pipelines, coils, containers, mechanical, optical, and electrical components;
household appliances, boilers, radiators;
flanges, valves, wall-fitted wardrobes, bed frames, insulation boxes, fence posts, garden furniture, traffic barriers, road signs, shopping baskets, inserts for dishwashers, brake cylinders, laboratory equipment, and chemical plants.
